(19) United States
(12) Patent Application Publication
(10) Pub. No.: US 2006/0135667 A1
(43) Pub. Date: Jun. 22, 2006

(54) Liquid electrical tape with flame retardant

(75) Inventors: Peter Dornau, Fort Lauderdale, FL (US); Robert R. Russo, East Rutherford, NJ (US); Jeffrey Tieger, Plantation, FL (US)

Correspondence Address: THE WEBB LAW FIRM, P.C., 700 KOPPERS BUILDING, 436 SEVENTH AVENUE, PITTSBURGH, PA, 15219, US

(73) Assignee: Star Brite Distributing, Inc., Fort Lauderdale, FL. (US)

(21) Appl. No.: 11/014,130

(22) Filed: Dec. 16, 2004

(51) Int. Cl. C08K 3/22; B32B 27/30

(52) U.S. Cl. 524/430; 428/522

(57) ABSTRACT

A quick drying liquid electrical tape formulation having good shelf life. The formulation forms a durable vinyl coating or film on wires, junctions and objects. The formulation is comprised of at least about 10% of a vinyl material effective to achieve the durable vinyl coating. The formulation further includes a thixotropic agent to add body, a plasticizer to impart flexibility to the vinyl coating and a flame retardant. The vinyl material, thixotropic agent plasticizer and a flame retardant are admixed with solvents comprising at least one drying agent. The formulation further including a stabilizing agent and at least one solvent, such that the thixotropic agent and plasticizer enable the application of a satisfactory coating using the formulation.

### BACKGROUND OF THE INVENTION

1. Field of the Invention

This invention relates to a liquid electrical tape formulations and more particularly, to a liquid electrical tape formulation that is vinyl resin based and which is solubilized into a mixture of organic solvents, and further includes a thixotropic agent, a plasticizer, a stabilizer, and a flame retardant.

2. Description of Related Art

Liquid electrical tape formulations have been developed in recent years to achieve an insulating coating, for instance, for protecting electrical connections, although such formulations have uses that range far beyond electrical connections, namely, to any object or area where an insulating or protective coating is desired, particularly where it is difficult to use conventional insulating tape.

Liquid electrical tape formulations are particularly useful in the marine and boating environments. In such harsh environments, standard electrical tape or shrink tubing does not perform well and can actually promote corrosion by allowing water to be trapped around electrical connections. Moreover, standard electrical tape or shrink tubing often cannot be used on very thin wiring, screw terminals or connections that are difficult to reach. Prior liquid electrical tape formulations tended either to have poor spreading or film forming characteristics or tend to become brittle with time. The shelf life of prior liquid electrical tape formulations has also been problematic. Long shelf life has been difficult to obtain because prior liquid electrical tape formulations normally harden quickly and tend to set, harden or polymerize in the container. In addition, in certain environments where there is risk of combustion, prior liquid electrical tape formulations may pose a risk of flammability.

Accordingly, a need remains for a liquid electrical tape that is safe and easy to use, which can brushed on or dipped onto various types of electrical connections, objects and other areas to be protected, has a long shelf life, quickly dries to a tough, yet flexible, ultraviolet resistant, dielectric coating that seals out dirt, moisture and water, thereby preventing corrosion, adheres to metal, plastic, vinyl, rubber and composite surfaces and can hold wires and terminals together, thereby preventing loose connections due to vibration and is flame resistant.

### SUMMARY OF THE INVENTION

The foregoing as well as other objects of the invention are achieved by providing a liquid electrical tape formulation for use in environments that are continuously exposed to vibration and moisture or, in some cases, are actually under water.

The liquid electrical tape formulation of the present invention may be used on bilge pumps, outdoor exposed wiring, sprinkler pumps, timers, underground wiring, outdoor lighting fixtures, instruments, computers and other places where a weatherproof and dependable connection is needed or where irregular shapes are involved.

In one embodiment of the present invention, the liquid electrical tape formulation is a vinyl resin that is solubilized into a mixture of organic solvents, with the further presence of a thixotropic agent, a plasticizer, a stabilizer, and a flame retardant.

### DETAILED DESCRIPTION OF THE INVENTION

The formulation of the present invention includes a resin composition that may include copolymers of vinyl compounds, such as copolymers of vinyl chloride and vinyl acetate where the vinyl chloride is present in a majority amount. These and any other polyvinyl materials are referred to herein as “vinyl” or “vinyl material”. The formulation of the present invention also includes a stabilizer and a flame retardant. The formulation may also include a thixotropic agent and a plasticizer and may be solvent borne.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

The resin composition may be a mixture of vinyl compounds. It is believed that the film forming features of the invention stem from the presence of at least one vinyl compound. If the vinyl component is substantially entirely vinyl chloride, the vinyl component will be less soluble in the other components, particularly the solvents, and will also be too crystalline. The presence of some polyvinyl acetate facilitates the formation of a good clear solution in the overall formulation. One non-limiting example of a suitable copolymer of vinyl chloride and vinyl acetate that provides good adhesion to substrates is VYHH available from The Dow Chemical Company of Midland, Mich. It should be understood that other vinyl materials may be employed in the present formula. The VYHH copolymer is composed of 86% by weight of vinyl chloride and 14% by weight of vinyl acetate. It has an approximate specific gravity of 1.36 and is normally presented in a solid granular form that is readily soluble in solvents used with the present invention.

The percentage of the vinyl copolymer component in the liquid electrical tape formulation of the present invention may vary from 10% to 60% by weight of the total mix and may be 25% by weight. At these levels, the vinyl component contributes sufficient vinyl material to produce a durable film of protective vinyl on the wire or junction or article to which the formulation of the present invention is applied.

The stabilizer may be an epoxy stabilizer composed of one or more functional liquid epoxy resins and may vary in the preferred liquid electrical tape formulation from 0.25% to 6% by weight. Non-limiting examples of suitable epoxy stabilizers include ERL 42-21 available from Dow Chemical Company or Shell EPON 828 from Shell Corporation. In some embodiments, it has been found that 5% by weight of ERL 42-21 in the overall formulation or 3% by weight of EPON 828 in the overall formulation is suitable. It has been determined that a formulation of the present invention lacking a stabilizer stored in a metal container at elevated temperatures will tend to release acid that interact with the inside surface of a metal container. This in turn will initiate unwanted polymerization of the vinyl resin. Likewise, acids that are frequently used to clean unfilled metal containers and acids that are present in solder used to construct metal containers can also initiate unwanted polymerization of the vinyl resin in the absence of a stabilizer. Non-epoxy stabilizers, compatible with other ingredients in the present formulation, may also be used to prevent premature polymerization of the formulation.

The flame retardant may be present in amounts of from 3% to 25% by weight or 5% to 7% by weight. A component that is “flame retardant” reduces or prevents the flammability of a formulation in which the component is included. Non-limiting examples of suitable flame retardants include antimony trioxide, decabromodiphenyl oxide, zinc molybdate complexed with magnesium silicate, calcium molybdate complexed with magnesium silicate, and phosphates such as phosphate esters, ammonium polyphosphates, and cyclic phosphates such as triaryl phosphate as well as mixtures thereof.

The thixotropic agent is believed to lend body or thickness to the liquid electrical tape formulation. This enhances film forming properties and prevents the formulation from running. As such, the formulation will tend to adhere to the surface to which it has been applied. If too much thixotropic agent is used, the overall formulation will not pour well. If too little is used, the formulation may be thin and runny. In one embodiment of the present invention, the amount of thixotropic agent may vary from 1% to 2% by weight. One non-limiting example of a suitable thixotropic agent is AC 4 Pliolite, available from Goodyear Corporation, Akron, Ohio. AC 4 Pliolite is a modified vinyl toluene acrylate copolymer having a melting point of 54° C. and a specific gravity of 2.08. Examples of other thixotropic agents that function satisfactorily in the present formulation are organic clays, fumed silicas and aluminum compounds.

The plasticizer affords flexibility to the dried or set liquid electrical tape formulation. Thus, the finished or set “tape” will not crack or separate under the force of vibration. The amount of plasticizer in the liquid electrical tape formulation may be from 5% to 15% by weight. Excessive plasticizer may cause the formulation to “weep” as the plasticizer migrates to the surface. Non-limiting examples of suitable plasticizers are dioctyl phthalate and dibenzoate esters, including K-flex plasticizer available from Noveon Kalama, Inc., Kalama, Wash. Examples of other plasticizers that function satisfactorily in the present formulation are castor oil, other phthalates and soy bean based plasticizers.

The ratio of vinyl component to plasticizer may be 2.5:1. Higher relative amounts of vinyl component may result in a relatively rigid final tape formation that will fracture and separate from the substrate on which the liquid electrical tape formation is coated. Ratios of 2:1 or less may result in failure of the formulation to harden properly.

The liquid electrical tape formulation may include a colorant mixture containing a colorant such as a pigment or dye. The colorant may be premixed with a plasticizer or other components to enhance dispersion of the colorant mixture in the formulation. In one embodiment of the invention, the colorant is present in amounts of 0.5 to 3.0% by weight. Suitable colorant mixtures include a plasticizer, an optional dispersant such as talc (e.g. Talc 399 from Luzenac America, Englewood, Calif.) and a colorant. For example, the colorant mixture may include by weight, 66.3% plasticizer, 0.7% dispersant, and 33% of a colorant such as titanium dioxide (for white color) or Phthalo Green (for green color) or Red 2B (for red color). Alternatively, the colorant mixture may include 58.7% plasticizer, 2.0% dispersant, and 39.3% carbon black. The colorant mixtures may be prepared in a high-speed disperser.

Other conventional additives may be included in the liquid electrical tape formulation of the present invention. Such other additives may include dispersants (e.g., talc) or other rheology control agents.

The balance of the liquid electrical tape of the present invention may be solvents present in an amount of 10% to 40% by weight. Non-limiting examples of suitable solvents include methyl ethyl ketone, toluene, xylene, acetone, methylene chloride and mixtures thereof. Toluene is a very effective drying agent. The flammability of toluene is controlled by including methylene chloride therewith. There may be a significant amount of methyl ethyl ketone in the formulation as it is an effective solvent for both the vinyl component and the thixotropic agent to keep these two components in solution. Methyl ethyl ketone also affords additional quick drying properties to the overall formulation.

The methyl ethyl ketone may be present in amounts of from 20% to 40% by weight. When the levels of methyl ethyl ketone are less than 20%, it may be difficult to maintain the vinyl material in solution which may result in a seeding out or thickening of a portion of the solids. When the level of methyl ethyl ketone is over 40%, a drying rate is increased and stability of the formulation in small quantities is reduced significantly.

The toluene may be present in amounts of from 10% to 15% by weight. If the amount of toluene exceeds 20%, the overall formulation may “skin” immediately and/or flash too quickly and dry on a brush used to apply the formulation. Toluene levels less than 10% tend to precipitate the vinyl component out of solution.

Methylene chloride has good flammability resistance and raises flashpoint to exceed 6° C. Methylene chloride also enhances the film forming or coating properties and may be present in a weight percentage range of from 10 to 20%.

In one embodiment, the liquid electrical tape formulation of the present invention is produced by dissolving the vinyl material in the solvent. The thixotropic agent, plasticizer, flame retardant and/or colorant mixture are dispersed into the solution. The formulation is applied to a substrate such as an electrical connection by conventional technique such as brushing, dipping or spraying. Upon evaporation of the solvent, the formulation dries to form a waterproof, flame retardant coating over the substrate.

The following example is intended to illustrate the invention, and should not be construed as limiting the invention in any way.

### EXAMPLE 1

A base formulation was prepared using the components of Table 1. A flame retardant composition was prepared by mixing together 20 wt. % antimony trioxide and 80 wt. % decabromodiphenyl oxide. Liquid electrical tape formulations of the present invention were prepared using the base formulation with the flame retardant composition added in 1 wt. % increments up to 10 wt. %. The components were added together as follows. The methyl ethyl ketone and xylene were introduced in a closed vessel. The thixotropic agent (AC 4 Pliolite) and the vinyl resin were slowly fed into the closed vessel under continuous agitation to insure proper dispersion. Mixing continued for at least 30 minutes. A check for dispersion was performed by removing a sample from the closed vessel and pouring it on a glass plate to confirm that particles not dissolved in the formulation were easily observable. The acetone was added, followed by another 15 minutes of mixing action. The plasticizer and flame retardant composition were slowly added to the mixture to avoid shocking the solution. After the plasticizer and flame retardant were added, the viscosity was checked. A suitable viscosity is between 2,000 and 2,500 centipoise on a Brookfield viscometer at 78° F., 20 RPM using a #4 spindle after five revolutions. Adjustments to viscosity were made using a combination of methyl ethyl ketone and xylene in a ratio of about 3:1. The adjustment of viscosity continued until a target of 2,000 to 2,500 centipoise was achieved.

TABLE 1

| COMPONENT | WT. % |
|---|---|
| VYHH vinyl resin | 24.2 |
| AC4 Pliolite thixotrope | 1.5 |
| K-Flex plasticizer | 7.4 |
| ERL 42-21 epoxy stabilizer | 5.1 |
| talc | 3.2 |
| colorant mixture* | 3.5 |
| methyl ethyl ketone | 38.6 |
| xylene | 8.5 |
| acetone | 8.0 |

*Colorant mixture 37.5 wt. % black pigment, 62.5 wt. % additional K-Flex plasticizer

The liquid electrical tape formulations consistently formed excellent coatings even after having been maintained in 4 fluid ounce (240 ml) metal containers for over 3 months at temperatures of 60° F. to 80° F. When applied as a coating, the formulation did not run or drip when coated on a wire, cable or object maintained at 250° F. After exposure at 0° F. for 72 hours, the coating maintained its flexibility and adhesion to the substrate.

A sample of each of the liquid electrical tape formulations (1-10 wt. % flame retardant composition in 1% increments) along with a sample of the base formulation (no flame retardant) was applied to a copper wire twisted connection and allowed to dry for 24 hours. Flame from a fireplace lighter was placed under each sample connection, and each sample connection was visually inspected. The control sample (no flame retardant) quickly softened and began to burn. The samples containing 1-5 wt. % flame retardant composition exhibited progressively less tendency to burn with increased amounts of flame retardant, but did support limited combustion. The samples containing 6 wt. % and above exhibited no combustion.

From the foregoing, it can be seen that there is provided, a liquid electrical tape formulation which has excellent shelf life and yet when applied to a desired surface, will form a vinyl resin film that is sufficiently flexible to be durable under the stress of vibration, will not readily crack for any other reason and is resistant to flames.

Whereas particular embodiments of this invention have been described above for purposes of illustration, it will be evident to those skilled in the art that numerous variations of the details of the present invention may be made without departing from the invention as defined in the appended claims.

The invention claimed is:

1. A liquid electrical tape formulation for forming a coating or film on wires, junctions and objects, said formulation comprising:
a vinyl material comprising a vinyl chloride copolymer including a major amount of vinyl chloride and a minor amount of vinyl acetate;
a stabilizing agent; and
a flame retardant.

2. The liquid electrical tape formulation of claim 1 wherein said vinyl material is present in an amount of 10 to 60 wt. %.

3. The liquid electrical tape formulation of claim 1 wherein said stabilizing agent is present in an amount of 3 to 5 wt. %.

4. The liquid electrical tape formulation of claim 1 wherein said flame retardant is present in an amount of 3 to 25 wt. %.

5. The liquid electrical tape formulation of claim 1, further comprising a plasticizer.

6. The liquid electrical tape formulation of claim 5 wherein said plasticizer is present in an amount of 5 to 15 wt. %.

7. The liquid electrical tape formulation of claim 1 further comprising a thixotropic agent.

8. The liquid electrical tape formulation of claim 7 wherein said thixotropic agent is present in an amount of 1 to 2 wt. %.

9. The formulation of claim 1 wherein said stabilizing agent is an epoxy based stabilizer present in an amount effective to prevent premature polymerization of the formulation.

10. The formulation of claim 5 wherein the plasticizer is dioctyl phthalate or a dibenzoate ester.

11. The formulation of claim 5 wherein the ratio by weight of vinyl material to plasticizer is in the range of about 2.5 to 1.

12. The liquid electrical tape formulation of claim 1 further comprising at least one solvent in an amount of 20 to 40 wt. %.

13. The formulation of claim 1 wherein the flame retardant is one or more component selected from the group consisting of antimony trioxide, decabromodiphenyl oxide, zinc molbdate complexed with magnesium silicate, calcium molbdate complexed with magnesium silicate, and a phosphate selected from the group consisting of phosphate esters, ammonium polyphosphates, and cyclic phosphates.

14. In a liquid electrical tape formulation including a vinyl material comprising a vinyl chloride copolymer including a major amount of vinyl chloride and a minor amount of vinyl acetate, a thixotropic agent, a stabilizing agent, and a plasticizer, the improvement comprising said formulation further comprising a flame retardant.

15. The liquid electrical tape formulation of claim 14 wherein when said vinyl material is present in an amount of 10 to 60 wt. %, said thixotropic agent is present in an amount of 1 to 2 wt. %, said stabilizing agent is present in an amount of 3 to 5 wt. %, said plasticizer is present in an amount of 5 to 15 wt. %, and said flame retardant is present in an amount of 3 to 25 wt. %.

16. The liquid electrical tape formulation of claim 14 wherein said flame retardant is one or more component selected from the group consisting of antimony trioxide, decabromodiphenyl oxide, zinc molbdate complexed with magnesium silicate, calcium molbdate complexed with magnesium silicate, and a phosphate selected from the group consisting of phosphate esters, ammonium polyphosphates, and cyclic phosphates.

17. An article coated with the formulation of claim 1.

18. An article coated with the formulation of claim 14.
